(19) United States
(12) Patent Application Publication
(10) Pub. No.: US 2015/0294020 A1
(43) Pub. Date: Oct. 15, 2015

(54) SYSTEM AND/OR METHOD FOR EVALUATING NETWORK CONTENT

(71) Applicants: Robin Daniel CHAMBERLAIN, Victoria (AU); Hamish Charles ROBERTSON, Victoria (AU)

(72) Inventors: Robin Daniel CHAMBERLAIN, Victoria (AU); Hamish Charles ROBERTSON, Victoria (AU)

(21) Appl. No.: 14/690,966

(22) Filed: Apr. 20, 2015

Related U.S. Application Data
(63) Continuation of application No. 12/595,443, filed on Dec. 23, 2009, now abandoned.

(30) Foreign Application Priority Data
Apr. 10, 2007 (AU) 2007901872

(51) Int. Cl. G06F 17/30; H04L 12/26; G06Q 30/00; H04L 29/08

(52) U.S. Cl. CPC G06F 17/30876; H04L 67/02; H04L 43/06; G06Q 30/018; G06F 17/30867

(57) ABSTRACT

A system and associated methods for use with the system for evaluating network content over a communications network. The system includes: at least one storage unit operable to store and/or maintain a plurality of forum facilities, each of the forum facilities being independently associated with a network location that contains network content; at least one processor operable to execute software that maintains and controls access to the forum facilities for a number of users; and, at least one input/output device operable to provide an interface for the users to operate the software in order to retrieve and view the forum facilities from the storage unit while simultaneously retrieving and viewing the network content from selected network locations via the communications network. The forum facilities include user generated content received from at least one user regarding network content available at selected network locations.

### TECHNICAL FIELD

The present invention relates generally, to a system and/or method for evaluating network content, and relates particularly, though not exclusively, to a system and/or method which enables World Wide Web (hereinafter simply referred to as “WWW”) content to be evaluated over the Internet. More particularly, the present invention relates to a system and/or method that enables web-users to evaluate the reputability and/or accuracy of WWW content by providing a forum facility which can be displayed simultaneously with the display of WWW content.

It will be convenient to hereinafter describe the invention in relation to a system and/or method for evaluating WWW content, however it should be appreciated that the present invention is not limited to that use only. The system and/or method of the present invention may also enable users to evaluate other forms of network content without departing from the spirit and scope of the invention as hereinafter described. Suitable forms of other network content include, but are not limited to, company information and/or documents accessible to company staff via an intranet, information and/or files obtainable via the so called File Transfer Protocol (hereinafter simply referred to as “FTP”), and/or files distributed using the newly developed BitTorrent, or similar, peer-to-peer software protocols. Accordingly, throughout the ensuing description the expressions “content” or “network content” are intended to refer to any suitable form of information, documents and/or files that is/are accessible to a user via a communications network.

Similarly, although the present invention is hereinafter described in relation to system and/or method which is provided to users via the Internet, it should be appreciated that the present invention is not limited to that use only.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure herein.

The development of the Internet has made a huge amount of content available to web-users. Never before has so much raw data, information, documents and/or files been available to so many. This sheer volume of network content has created its own problems as well as its own opportunities—one of which has been the tremendous popularity of the search engine. However, as effective as a search engine is at finding raw information, web-users still have little way of knowing if the information contained within a particular website is reputable and accurate, or misleading and deceptive.

Given that the WWW is essentially a free resource, almost anything can be published online with little scrutiny. As e-commerce increases and the number of transactions over the Internet grow, the need to distinguish between reputable and un-reputable online vendors becomes extremely important. Yet to date, there have been few, if any, effective methods for objectively evaluating the quality and accuracy of content provided on the WWW.

It is therefore an object of the present invention to provide a system and/or method for evaluating network content, preferably WWW content.

### DISCLOSURE OF THE INVENTION

According to one aspect of the present invention there is provided a method for evaluating network content over a communications network, said method including the steps of: providing at least one network server which stores and/or maintains a plurality of forum facilities, each of said forum facilities being independently associated with a network location that contains network content; providing at least one user operable terminal with controlled access to said at least one network server and said forum facilities stored thereon; receiving and processing at said at least one network server a request sent from said at least one user operable terminal, via said communications network, to view and/or acquire network content from a selected one of said network locations; and, displaying and/or providing said network content on and/or to said at least one user operable terminal whilst simultaneously displaying said forum facility independently associated with said selected network location.

Preferably said method for evaluating network content further includes the steps of: receiving user generated content from at least one of said user operable terminals, via at least one of said forum facilities, regarding network content available at selected ones of said network locations; storing said user generated content on said at least one network server; selectively updating said at least one of said forum facilities with said user generated content relevant thereto; and, making said updated forum facilities available to all of said user operable terminals; wherein said user generated content enables users of said at least one user operable terminals to evaluate network content available at said selected ones of said network locations.

Preferably said user generated content includes, but is not limited to: threads; hyper-links; file attachments; and/or, embedded video, image or sound files. It is also preferred that said users are provided with a means of rating said user generated content such that said network server may utilise user ratings received in order to determine the order of display of said user generated content within said message boards.

In a practical preferred embodiment said at least one network server is at least one computing device which preferably includes at least one processor which is operable to execute software that maintains and controls access to said forum facilities for said user operable terminals. Preferably said forum facilities are message boards that are stored on at least one memory or storage unit associated with said at least one computing device.

In a further practical preferred embodiment said at least one computing device is a web-server accessible to said at least one user operable terminal via said communications network, preferably the Internet, wherein said users can access said web-server via at least one software application installed on said at least one user operable terminal which may be permanently, or selectively, connected to said Internet. In this practical preferred embodiment said network content is WWW content and each of said message boards are independently associated with a network location, preferably a registered domain name, containing said WWW content. Preferably said at least one user operable terminal is selected from the group consisting of: a PDA; a mobile or cellular telephone; a personal, tablet or notebook computer; or any other suitable computing or communications device. It is preferred that said message boards of said method for evaluating network content of the present invention provide an online or virtual community which is accessible to said users in real time, i.e. “live”. The provision of said message boards which are accessible to said users simultaneously with the display of said WWW content enables said users to evaluate the reputability and/or accuracy of said WWW content.

Preferably said method for evaluating network content further includes the steps of: querying said Internet at predetermined intervals to locate available registered domain names; acquiring and storing at least selected ones of said available registered domain names in at least one database associated with said web-server; and, generating a message board for each of said available registered domain names stored in said at least one database.

In yet a further practical preferred embodiment said web-server is a search engine and said at least one software application installed on said at least one user operable terminal is a web-browser graphical user interface (hereinafter simply referred to as “GUI”). In one form of this practical preferred embodiment said request sent from said at least one user operable terminal to said search engine, via said Internet, is accomplished by said users clicking on hyper-links or buttons displayed within said web-browser GUI that are associated with selected registered domain names containing said WWW content that are displayed after a search has been performed. In a further form of this practical preferred embodiment said request sent from said at least one user operable terminal to said search engine, via said Internet, is accomplished by said users entering a selected registered domain name directly into a search field provided by said search engine within said web-browser GUI. Preferably after sending said request to said search engine, said web-browser GUI simultaneously displays said WWW content and its independently associated message board: utilising a single screen of said web-browser GUI; or, utilising multiple screens, pop-up windows or tabs of said web-browser GUI. It is further preferred that the display of said message boards within said web-browser GUI may be selectively collapsed, moved, resized and/or removed depending on a users preference.

In an alternative practical preferred embodiment said web-server is a dedicated network content evaluation server which may be used by said users to simultaneously display said WWW content and said independently associated message boards. In this embodiment it is also preferred that said at least one software application installed on said at least one user operable terminal is a web-browser GUI. In one form of this practical preferred embodiment said request sent from said at least one user operable terminal to said dedicated network content evaluation server, via said Internet, is accomplished by said users entering a selected registered domain name directly into a search field built into said web-browser GUI, or a search field provided on a website displayed within said web-browser GUI. Preferably after sending said request to said dedicated network content evaluation server, said web-browser GUI simultaneously displays said WWW content and its independently associated message board: utilising a single screen of said web-browser GUI; or, utilising multiple screens, pop-up windows or tabs of said web-browser GUI. It is further preferred that the display of said message boards within said web-browser GUI may be selectively collapsed, moved, resized and/or removed depending on a users preference.

In an alternative form of either one of the practical preferred embodiments described in the preceding paragraphs, said WWW content and said independently associated message boards may be simultaneously displayed by utilising a web-browser GUI plug-in, such as, for example, a toolbar or web-browser add-on.

In yet a further practical preferred embodiment said web-server is a search engine or a dedicated network content evaluation server and said user operable terminals include two software applications installed thereon. A first of said two software applications being a web-browser GUI for displaying said WWW content, and a second of said two software applications being a dedicated message board GUI for displaying said independently associated message boards. In this further practical preferred embodiment said users may selectively use both of said software applications to simultaneously display said WWW content and said independently associated message boards.

Preferably each of said message boards includes at least one advertising space which can be used to display advertisements and/or sponsored links to said users. In a practical preferred embodiment, said advertisements and/or sponsored links displayed within said at least one advertising space provided on said message boards may change based on: the changing content of said user generated content displayed within said message boards; and/or, the WWW content associated with said message boards. The provision of said advertisements and/or sponsored links provided within said message boards that are displayed simultaneously with WWW content enables the creation of competition not before achievable on the WWW.

According to a further aspect of the present invention there is provided a machine readable medium storing a set of instructions that, when executed by a machine, cause the machine to execute a method for evaluating network content over a communications network, said method including the steps of: providing a central repository for storing and/or maintaining a plurality of forum facilities, each of said forum facilities being independently associated with a network location that contains network content; providing at least one user operable terminal with controlled access to said central repository and said forum facilities stored therein; receiving and processing a request sent from said at least one user operable terminal, via said communications network, to view and/or acquire network content from a selected one of said network locations; and, displaying and/or providing said network content on and/or to said at least one user operable terminal whilst simultaneously displaying said forum facility independently associated with said selected network location.

According to yet a further aspect of the present invention there is provided a computer program including computer program code adapted to perform some or all of the steps of the method as described with reference to any one of the preceding paragraphs, when said computer program is run on a computer.

According to yet a further aspect of the present invention there is provided a computer program according to the preceding paragraph embodied on a computer readable medium.

According to yet a further aspect of the present invention there is provided a system for evaluating network content, said system being operable over a communications network, said system including: at least one memory or storage unit operable to store and/or maintain a plurality of forum facilities, each of said forum facilities being independently associated with a network location that contains network content; at least one processor operable to execute software that maintains and controls access to said forum facilities for a plurality of users; and, at least one input/output device operable to provide an interface for said plurality of users to operate said software in order to retrieve and view said forum facilities from said at least one memory or storage unit whilst simultaneously retrieving and viewing said network content from selected ones of said network locations via said communications network; wherein said forum facilities stored and/or maintained on said at least one memory or storage unit include user generated content received from at least one of said plurality of users regarding network content available at selected ones of said network locations.

Preferably said user generated content includes, but is not limited to: threads; hyper-links; file attachments; and/or, embedded video, image or sound files. It is also preferred that said plurality of users are provided with a means of rating said user generated content such that said system may utilise user ratings received in order to determine the order of display of said user generated content within said message boards.

In a practical preferred embodiment said system includes at least one computing device having said at least one processor and said at least one memory or storage unit associated therewith. Preferably said at least one computing device is a network server connected to said communications network. It is also preferred that said network server is a web-server accessible to said plurality of users via said communications network, preferably the Internet. In this practical preferred embodiment said at least one input/output device is associated with at least one user operable terminal, wherein each of said plurality of users can access said forum facilities stored and/or maintained on said web-server via at least one software application installed on said at least one user operable terminal which may be permanently, or selectively, connected to said Internet. Preferably said at least one user operable terminal is selected from the group consisting of: a PDA; a mobile or cellular telephone; a personal, tablet or notebook computer; or any other suitable computing or communications device.

Preferably said network content is WWW content and each of said forum facilities, preferably message boards, are independently associated with a network location, preferably a registered domain name, containing said WWW content. It is also preferred that said message boards of said system of the present invention provide an online or virtual community which is accessible to said plurality of users in real time, i.e. “live”. The provision of said message boards which are accessible to said plurality of users simultaneously with the display of said WWW content enables said plurality of users to evaluate the reputability and/or accuracy of said WWW content.

Preferably said web-server queries said Internet at predetermined intervals to locate available registered domain names, and then acquires and stores at least selected ones of said available registered domain names in at least one database associated with said web-server. It is also preferred that said web-server generates a message board for each of said available registered domain names stored in said at least one database.

In a further practical preferred embodiment said web-server is a search engine and said at least one software application installed on said at least one user operable terminal is a web-browser GUI. In one form of this practical preferred embodiment said plurality of users can simultaneously display said WWW content and said independently associated message boards by clicking on hyper-links or buttons displayed within said web-browser GUI that are associated with selected registered domain names containing said WWW content that are displayed after a search has been performed. In a further form of this practical preferred embodiment said plurality of users can simultaneously display said WWW content and said independently associated message boards by entering a selected registered domain name directly into a search field provided by said search engine within said web-browser GUI. Preferably said web-browser GUI simultaneously displays said WWW content and its independently associated message board: utilising a single screen of said web-browser GUI; or, utilising multiple screens, pop-up windows or tabs of said web-browser GUI. It is further preferred that the display of said message boards within said web-browser GUI may be selectively collapsed, moved, resized and/or removed depending on a users preference.

In an alternative practical preferred embodiment said web-server is a dedicated network content evaluation server which may be used by said plurality of users to simultaneously display said WWW content and said independently associated message boards. In this embodiment it is also preferred that said at least one software application installed on said at least one user operable terminal is a web-browser GUI. In one form of this practical preferred embodiment said plurality of users can simultaneously display said WWW content and said independently associated message boards by entering a selected registered domain name directly into a search field built into said web-browser GUI, or a search field provided on a website displayed within said web-browser GUI. Preferably said web-browser GUI simultaneously displays said WWW content and its independently associated message board: utilising a single screen of said web-browser GUI; or, utilising multiple screens, pop-up windows or tabs of said web-browser GUI. It is further preferred that the display of said message boards within said web-browser GUI may be selectively collapsed, moved, resized and/or removed depending on a users preference.

In an alternative form of either one of the practical preferred embodiments described in the preceding paragraphs, said WWW content and said independently associated message boards may be simultaneously displayed by utilising a web-browser GUI plug-in, such as, for example, a toolbar or web-browser add-on.

In yet a further practical preferred embodiment said web-server is a search engine or a dedicated network content evaluation server and said user operable terminals include two software applications installed thereon. A first of said two software applications being a web-browser GUI for displaying said WWW content, and a second of said two software applications being a dedicated message board GUI for displaying said independently associated message boards. In this further practical preferred embodiment said plurality of users may selectively use both of said software applications to simultaneously display said WWW content and said independently associated message boards.

Preferably each of said message boards includes at least one advertising space which can be used to display advertisements and/or sponsored links to said plurality of users. In a practical preferred embodiment, said advertisements and/or sponsored links displayed within said at least one advertising space provided on said message boards may change based on: the changing content of said user generated content displayed within said message boards; and/or, the WWW content associated with said message boards. The provision of said advertisements and/or sponsored links provided within said message boards that are displayed simultaneously with WWW content enables the creation of competition not before achievable via on WWW.

According to yet a further aspect of the present invention there is provided a system for evaluating network content, preferably WWW content, said system being operable over a communications network, preferably the Internet, said system including: at least one network server connected to said communications network, said at least one network server, preferably a web-server, acting as a central repository for storing and/or maintaining a plurality of forum facilities, each of said forum facilities being independently associated with a network location, preferably a registered domain name, that contains network content; and, at least one user operable terminal which can be selectively connected to said communications network for retrieving and displaying said forum facilities from said at least one network server whilst simultaneously retrieving and displaying said network content from selected ones of said network locations available via said communications network; wherein said forum facilities stored and/or maintained on said at least one network server include user generated content received from at least one user of said at least one user operable terminal regarding network content available at selected ones of said network locations.

According to yet a further aspect of the present invention there is provided a method for evaluating WWW content over the Internet, said method including the steps of: querying said Internet at predetermined intervals to locate available registered domain names; acquiring details pertaining to at least selected ones of said available registered domain names; generating a forum facility for all of said available registered domain names for which details were acquired; and, selectively making said forum facilities available to WWW users for the purpose of evaluating WWW content available at associated registered domain names.

Preferably said forum facilities are message boards which are each independently associated with a respective available registered domain name. It is further preferred that said method further includes the step of: displaying said WWW content simultaneously with the display of said independently associated message board for each available registered domain name.

According to yet a further aspect of the present invention there is provided a method for evaluating WWW content over the Internet, said method including the steps of: providing a central repository for storing and/or sharing user generated hyper-links, each of said user generated hyper-links being related to a network location that contains WWW content; providing at least one user operable terminal with controlled access to said central repository and said user generated hyper-links stored therein; receiving and processing a request sent from said at least one user operable terminal, via said Internet, to view and/or acquire WWW content from a selected one of said network locations; and, displaying and/or providing said network content on and/or to said at least one user operable terminal whilst simultaneously displaying said user generated hyper-links associated with said selected network location.

### Advantages of the Invention

Accordingly, the present invention provides a system, method and/or computer program for evaluating network content, preferably WWW content, utilising a communications network, such as, for example, the Internet.

In a preferred form, the present invention provides a software and/or hardware system which is operable to enable users to make informed decisions in relation to network content. The system, which is preferably provided as an add-on to, or is integrated into, a search engine, provides an interactive forum environment that can be displayed simultaneously with independently associated network content within at least one GUI. The system of the present invention preferably enables the creation of a virtual community of network content conscience individuals that can interactively exchange opinions and/or information to generate objective and useful information that other network users can utilise to help them make informed decisions regarding network content.

The present invention therefore provides a system and/or method for evaluating network content that can improve the functionality and/or usefulness of the Internet by allowing users to interact with network content and/or each other in a way that has never before been possible.

According to an advantageous embodiment of the present invention, web-users can receive feedback from other web-users about products and/or services available for purchase from an e-commerce website. For example, after accessing a number of e-commerce websites by clicking through from a search engine GUI, a web-user can determine whether they should purchase from a specific e-commerce website by selectively reviewing the associated message board provided by the system of the present invention. In this way, a web-user might choose to purchase from an e-commerce website having a large number of positive comments provided in the message board associated therewith.

The advantages of the system and/or method for evaluating network content of the present invention are not just limited to e-commerce related websites. For example, the message boards provided by the present invention could also be used as a means for web-users to post information, etc, which points out any errors or inaccuracies related to the content displayed on a particular website, e.g. if a scientist reads an article posted on a website and comes across any factual errors, etc, he/she could post threads, links and/or attachments on the message board associated with that website to inform future web-users of those errors. The message boards of the present invention could also be used by web-users to post threads, etc, to praise and/or congratulate a website owner and/or designer for the content/usability of their website.

When embodied as an add-on to a search engine, or integrated into a search engine, the system for evaluating network content of the present invention will complement and/or enhance the search facilities already provided by that search engine. Furthermore, when advertising space is provided within the message boards of the present invention, the sale of those advertising spaces will significantly improve advertising revenue for that search engine company. Advanced data mining of user generated content contained within these message boards, and/or the WWW content associated therewith, will further refine delivery of advertisements, etc, to web-users.

The network content evaluation system and/or method of the present invention is clearly superior to current search engine models as it not only provides a unique means of evaluating WWW content, but also enables the generation and storage of an enormous volume of user generated information that can be, for example, used by a search engine company for target advertising purposes. As advertising space is preferably provided within the message boards users of the system and/or method are likely to be exposed to advertisements for longer periods of time. This may entice more companies/individuals to purchase advertising space from a search engine company. For example, within a usual search engine screen a web-user may only be exposed to an advertisement for say 30 seconds until they selectively choose to click through to a website of interest. However, when using the system of the present invention should a web-user choose to view the message board associated with a website, they may end up being exposed to an advertisement for a significantly longer time, say 30 minutes depending on the time it takes them to view and/or post threads on that message board. Thus, advertising space on independently associated message boards may command significantly higher premiums than standard advertising spaces provided within a conventional search engine results window.

Hence, the system and/or method for evaluating network content of the present invention therefore improves the functionality and usefulness of the internet by, for example: allowing users to post and/or view threads, links, attachments, etc, on message boards independently associated with websites, which in turn provides web-users with a means of assessing the reputability of a website provider and/or the accuracy of content or the quality of goods and/or services provided on that website; and/or, allowing web-users of a particular website to interact with other web-users in a way that has never before been provided.

### BRIEF DESCRIPTION OF THE DRAWINGS

In order that the invention may be more clearly understood and put into practical effect there shall now be described in detail preferred constructions of a system and/or method for evaluating network content in accordance with the invention. The ensuing description is given by way of non-limitative example only and is with reference to the accompanying drawings, wherein:

FIG. 1 is a block diagram of a system for evaluating network content, made in accordance with a preferred embodiment of the present invention;

FIG. 2 is an exemplary GUI illustrating a preferred way of simultaneously displaying a website and its independently associated message board within a GUI in accordance with the system for evaluating network content of FIG. 1;

FIGS. 3a & 3b are a flow diagram illustrating one embodiment of a method for evaluating network content, which is suitable for use with the system for evaluating network content of FIG. 1;

FIGS. 4a & 4b are exemplary GUI's illustrating preferred examples of the use of the system for evaluating network content of FIG. 1, wherein it is shown that a web-user is able to simultaneously view a website and its independently associated message board by entering a selected registered domain name directly into a search field built into a web-browser, or provided on a website displayed within a web-browser, utilising for example, the method for evaluating network content of FIGS. 3a & 3b;

FIGS. 5a & 5b are exemplary GUI's illustrating further preferred examples of the use of the system for evaluating network content of FIG. 1, wherein it is shown that a web-user is able to simultaneously view a website and its independently associated message board by clicking on a hyper-link or button provided within a results screen of a search engine website, utilising for example, the method for evaluating network content of FIGS. 3a & 3b;

FIG. 6 is an exemplary GUI illustrating yet a further preferred example of the use of the system for evaluating network content of FIG. 1, wherein it is shown that a web-user is able to simultaneously view a website and its independently associated message board by clicking on a hyper-link provided within a website, such as, for example, a sponsored website hyper-link provided within a results screen of a search engine website, utilising for example, the method for evaluating network content of FIGS. 3a & 3b;

FIGS. 7a to 7c are exemplary GUI's illustrating yet further preferred examples of the use of the system for evaluating network content of FIG. 1, wherein it is shown that a web-user is able to simultaneously view a website and its independently associated message board within one or more GUI's by the use of a web-browser plug-in, or toolbar, utilising for example, the method for evaluating network content of FIGS. 3a & 3b; and,

FIG. 8 is an exemplary GUI illustrating yet a further preferred example of the use of the system for evaluating network content of FIG. 1, wherein it is shown that a web-user is able to display independently associated message boards within a dedicated message board GUI, utilising for example, the method for evaluating network content of FIGS. 3a & 3b.

### MODES FOR CARRYING OUT THE INVENTION

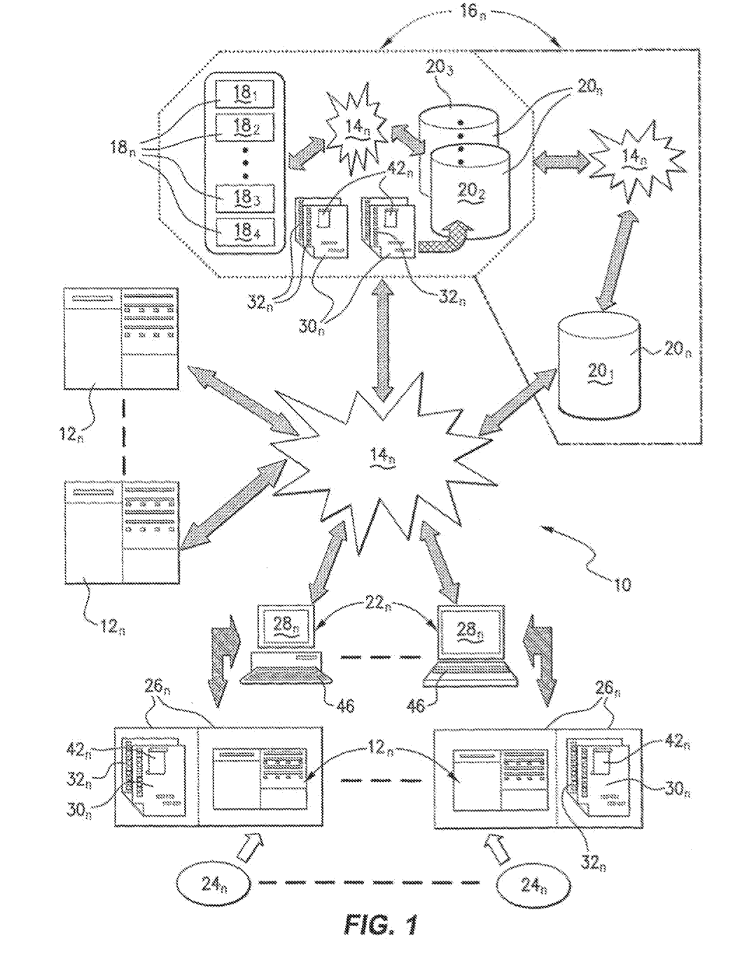

In FIG. 1 there is shown a system 10 for evaluating network content 12ₙ, for example, WWW content 12ₙ as shown. System 10 is suitable for use over a communications network 14ₙ. It should be understood however, that system 10 of the present invention is not limited to that use only.

System 10 includes at least one network server 16ₙ which hosts and/or maintains a plurality of tools or applications 18ₙ, and databases 20ₙ that together provide a means of evaluating WWW content 12ₙ.

Network server 16ₙ is designed to receive/transmit data from/to at least one input terminal 22ₙ. The term “Input terminal 22ₙ” refers to any suitable type of computing device capable of transmitting/receiving and displaying data as described herein, including, but not limited to, a Personal Digital Assistant (PDA) as for example a Palm Pilot®, a Wireless Application Protocol (WAP) capable communications device, as for example, a mobile or cellular phone, and/or any other suitable computing device, as for example a personal/desktop, or notebook computer.

Network server 16ₙ is configured to communicate with input terminals 22ₙ via any suitable communications connection or network 14ₙ (hereinafter referred to simply as a “network(s) 14ₙ”). Input terminals 22ₙ are configured to display and/or retrieve network content 12ₙ from network 14ₙ. Each input terminal 22ₙ may communicate with network server 16ₙ and/or network content 12ₙ via the same or a different network 14ₙ. Suitable networks 14ₙ include, but are not limited to: a Local Area Network (LAN); a Personal Area Network (PAN), as for example an Intranet; a Wide Area Network (WAN), as for example the Internet; a Wireless Application Protocol (WAP) network; a Bluetooth network; and/or any suitable WiFi network (wireless network). Network server 16ₙ may include various types of hardware and/or software necessary for communicating with input terminals 22ₙ and/or additional computers/hardware (not shown) as for example routers, switches, access points and/or Internet gateways, each of which would be deemed appropriate by persons skilled in the relevant art.

Input terminals 22ₙ are each configured to be operated by at least one user 24ₙ of system 10. The term “user 24ₙ” refers to any person in possession of, or stationed at, at least one input terminal 22ₙ whom is able to operate input terminal 22ₙ and transmit/receive data and/or display/retrieve network content 12ₙ, as for example, a web-user, a staff member accessing an Intranet, and/or any other form of network user utilising any suitable software protocol, such as, for example, the so-called FTP and/or BitTorrent or similar protocols. Input terminals 22ₙ may include various types of software and/or hardware required for capturing and/or displaying network content 12ₙ including, but not limited to: web-browser or other GUI application(s) 26ₙ; monitor(s) 28ₙ; GUI pointing devices (not shown); and/or, any other suitable data acquisition or display device(s) (not shown). Similarly, input terminals 22ₙ may also include various types of software and/or hardware suitable for transmitting/receiving data to/from network server 16ₙ via network(s) 14ₙ.

Although the use of system 10 is specifically described with reference to users 24ₙ utilising input terminals 22ₙ to connect to, and interact with, network server 16ₙ, via network 14ₙ, it should be appreciated that system 10 of the present invention is not limited to that use only. In an alternative embodiment (not shown) users 24ₙ may simply interact directly with network server 16ₙ which may be their own personal computing device or a public computing device, as for example an Internet kiosk, library or Internet Café computing device(s). In this alternative embodiment, system 10 could be provided entirely by a single network server 16ₙ as a software and/or hardware application(s) and as such input terminals 22ₙ would not be essential to the operation of system 10. The present invention is therefore not limited to the specific arrangement shown in the drawings.

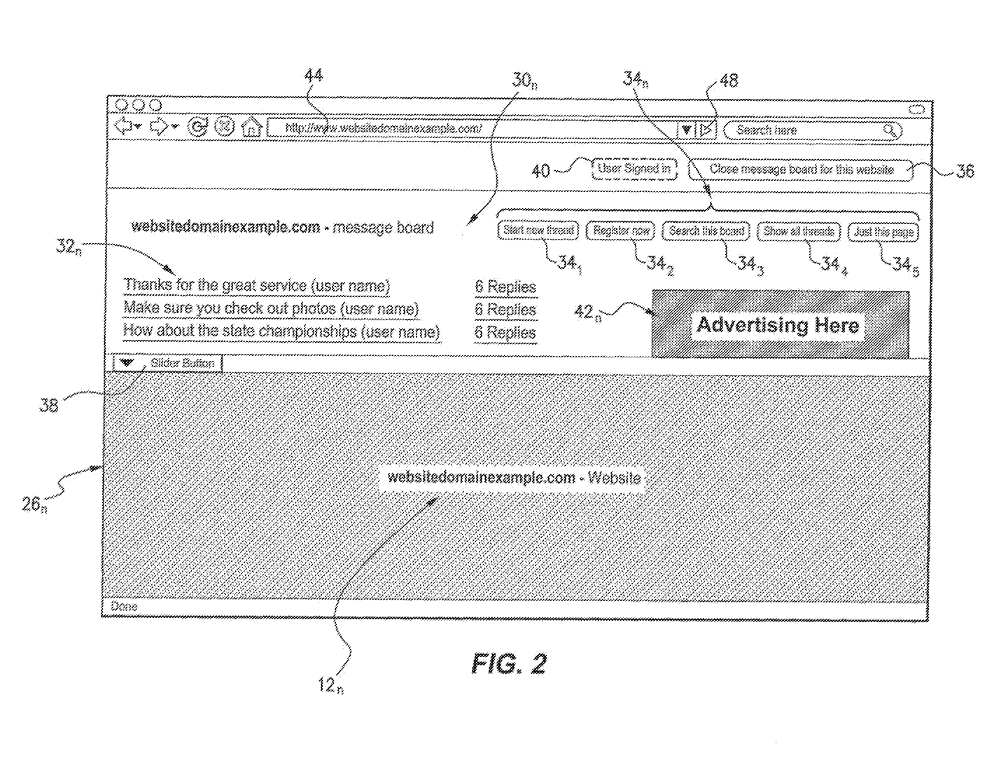

As is shown in FIG. 1, and explained in more detail with reference to FIGS. 2 to 8, it is preferred that network server 16ₙ is at least one web-server, or is connected via network(s) 14ₙ to at least one additional network server 16ₙ (not shown) acting as a web-server, such that system 10 is an online service accessible to users 24ₙ in possession of, or stationed at, input terminals 22ₙ connected to the Internet (network(s) 14ₙ).

System 10 may be available to users 24ₙ for free, or may be offered to users 24ₙ on an “on demand” Application Service Provider (hereinafter simply referred to as “ASP”) basis, with use thereof being charged accordingly. ASP usage may only apply to a select group of users 24ₙ, such as, for example, professional and/or corporate users 24ₙ, who may be heavy users of system 10.

It is preferred that network server 16ₙ utilises security to validate access from input terminals 22ₙ. It is also preferred that network server 16ₙ performs validation functions to ensure the integrity of data transmitted between network server 16ₙ and input terminals 22ₙ. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data validation technologies as would be deemed appropriate by a person skilled in the relevant art.

Communication and/or data transfer between input terminals 22ₙ and network server 16ₙ, via network(s) 14ₙ, and/or the display of network content 12ₙ retrieved from network 14ₙ on input terminals 22ₙ, may be achieved utilising any suitable communication and/or data transfer protocol, such as, for example, FTP, Hypertext Transfer Protocol (hereinafter simply referred to as “HTTP”), Electronic Mail (hereinafter simply referred to as “e-mail”), Transfer Control Protocol/Internet Protocol (hereinafter simply referred to as “TCP/IP”), Short Message Service (hereinafter simply referred to as “SMS”), Multimedia Message Service (hereinafter simply referred to as “MMS”), any suitable Internet based message service, any combination of the preceding protocols and/or technologies, and/or any other suitable protocol or communication technology that allows delivery of network content 12ₙ and/or communication/data transfer between input terminals 22ₙ and network server 16ₙ.

Access to network server 16ₙ, and the transfer of network content 12ₙ between input terminals 22ₙ and network server 16ₙ, may be intermittently provided (for example, upon request), but is preferably provided “live”, i.e. in real-time.

System 10 is designed to enable users 24ₙ to make informed decisions in relation to network content 12ₙ by providing an interactive forum environment that can be displayed simultaneously with independently associated network content 12ₙ within at least one GUI 26ₙ.

Network server 16ₙ, of system 10, includes a plurality of applications 18ₙ (such as software and/or hardware modules or engines) and databases 20ₙ that enable multiple aspects of system 10 to be provided over network 14ₙ. These applications 18ₙ and databases 20ₙ include, but are not limited to: a network address database 20₁; a forum facility database 20₂; a user database 20₃; a module or application for generating, maintaining and/or displaying forum facilities 18₁ (hereinafter simply referred to as “forum facility display engine 18₁”); a user registration and/or sign-in/sign-out engine 18₂ (hereinafter simply referred to as “user administration engine 18₂”); a user generated content capture and/or administration engine 18₃ (hereinafter simply referred to as “UGC administration engine 18₃”); and/or, an advertisement and/or sponsored hyper-link placement engine 18₄ (hereinafter simply referred to as “advertising engine 18₄”).

Databases 20₁, 20₂, 20₃ . . . 20ₙ are preferably managed by a Database Management System(s) (hereinafter simply referred to as “DBMS(s)”) installed on network server 16ₙ that enables data to be stored, modified, searched and/or extracted from respective databases 20₁, 20₂, 20₃ . . . 20ₙ. DBMS(s) (not shown) work with modules 18₁, 18₂, 18₃, 18₄ . . . 18ₙ of system 10 to enable the storage, searching, display and/or extraction of system and/or user input data.

A detailed description of each of these databases 20ₙ and applications 18ₙ of system 10 will now be provided.

### Network Address Database:

Network address database 20₁ stores and/or maintains data pertaining to available network 14ₙ locations that contain network content 12ₙ. In accordance with a preferred embodiment of the present invention, these network 14ₙ locations are registered domain names which identify Internet 14ₙ addresses or locations of WWW content 12ₙ.

Network address database 20₁ stores registered domain name data captured or acquired by system 10 and/or a third party provider (not shown), such as, for example, an Internet Corporation for Assigned Names and Numbers. Registered domain name data stored in network address database 20₁ is used by forum facility display engine 18₁ of system 10 to generate forum facilities 30ₙ that are subsequently stored and/or maintained in forum facility database 20₂.

In FIG. 1, network server 16ₙ is shown in two distinct sections, each separated by a different style of phantom lines, to illustrate that network address database 20₁ of system 10 may be provided and/or maintained by a third party network server 16ₙ. Hence, networks 14ₙ are shown interconnecting databases 20ₙ to represent that they can be provided by different network servers 16ₙ.

Although illustrated as possibly being provided by a different or third party network server 16ₙ, it should be appreciated that network address database 20₁ may simply be embodied as part of a single network server 16ₙ of system 10. Hence, networks 14ₙ may simply be data buses 14ₙ interconnecting the various components, databases 20ₙ and/or applications 18ₙ of network server 16ₙ.

It should therefore be appreciated that the actual location and/or provider of network address database 20₁, and/or the registered domain name data stored therein, is not essential to the operation of system 10 of the present invention.

### Forum Facility Database:

Forum facility database 20₂ stores and/or maintains data pertaining to forum facilities 30ₙ generated by forum facility display engine 18₁ of system 10, as well as user generated content 32ₙ (e.g. user posts, threads, links, attachments, etc) captured and subsequently displayed within forum facilities 30ₙ.

In accordance with a preferred embodiment of the present invention, these forum facilities 30ₙ are message boards 30ₙ, each of which are independently associated with a particular registered domain name stored in network address database 20₁.

Message boards 30ₙ provide users 24ₙ with a means of evaluating WWW content 12ₙ in order to help them make informed decisions regarding the reputability and/or accuracy of that WWW content 12ₙ. By selectively reviewing user generated content 32ₙ posted by users 24ₙ of system 10 on message boards 30ₙ, a user 24ₙ can objectively assess whether they can trust and/or rely on WWW content 12ₙ they are simultaneously viewing within at least one GUI 26ₙ installed on their input terminal 22ₙ.

An exemplary web-browser GUI 26ₙ illustrating a preferred construction of a message board 30ₙ displayed simultaneously with its associated WWW content 12ₙ (e.g. a website 12ₙ) is shown in FIG. 2.

Referring to FIG. 2, it can be seen that a message board 30ₙ may include a plurality of icons and/or buttons 34ₙ that allow a user 24ₙ of system 10 to perform a number of message board 30ₙ functions. For example, these buttons 34ₙ may include, but are not limited to: a ‘start new thread’ button 34₁ which may be used to submit user generated content 32ₙ; a ‘register now’ button 34₂ which may be used to allow a new user 24ₙ to register to post threads (i.e. user generated content 32ₙ) on message boards 30ₙ of system 10; a ‘search this board’ button 34₃ which may enable a user 24ₙ to search user generated content 32ₙ contained within a message board 30ₙ; a ‘show all threads’ button 34₄ that may enable a user 24ₙ to selectively choose to see all available threads or posts 32ₙ for a particular website 12ₙ; and/or, a ‘just this page’ 34₅ button which may enable a user 24ₙ to selectively choose to see only the threads or posts 32ₙ available for a particular web-page 12ₙ (as opposed to an entire website 12ₙ) they are viewing.

Message boards 30ₙ may also include: an open/close message board button 36; a message board slider or size adjustment button 38; an icon or display section 40 provided near open/close message board button 36 provided to show users 24ₙ whether they are signed-in or signed-out, and/or to allow them to sign-in and sign-out as necessary; and/or, at least one advertising space 42ₙ. Open/close button 36 enables users 24ₙ to selectively choose whether they wish to view a message board 30ₙ associated with WWW content 12ₙ they are viewing. Slider button 38 may be utilised by users 24ₙ to selectively adjust the size of the display of message board 30ₙ within a GUI 26ₙ. Advertising space 42ₙ provides a convenient location for the placement of advertisements and/or sponsored hyper-links, etc, utilising, for example, advertising engine 18₄ of system 10 of the present invention.

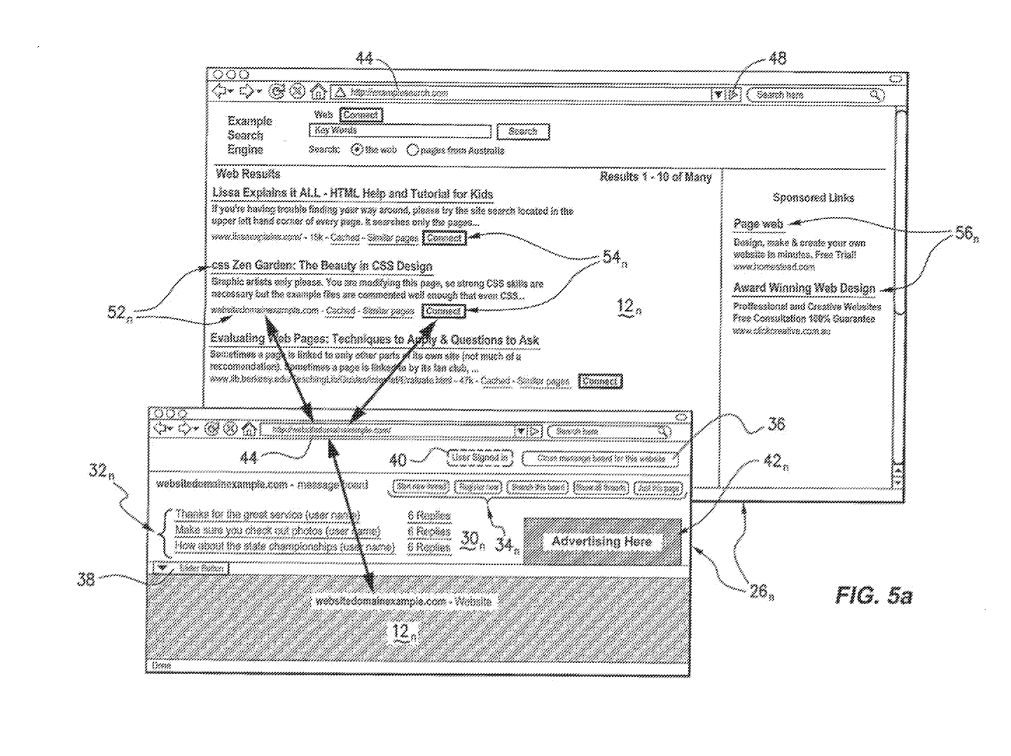

Message boards 30ₙ may be used by users 24ₙ of system 10 to, for example, post: tips regarding a website 12ₙ (e.g. advice regarding the best areas of a website 12ₙ to view); positive/negative views regarding their own experience regarding the content/use of a website 12ₙ; attachments, e.g. photos, videos, or embedded video, image or sound files or messages, related to the website 12ₙ content; and/or, links, e.g. hyper-links to related websites 12ₙ, to other similar or preferred websites 12ₙ that they recommend viewing and/or using. Such links 32ₙ may be provided within a separate page or area (not shown) of message board 30ₙ, meaning that users 24ₙ may need to selectively click on a ‘linked sites’ button (not shown) that could conveniently be located alongside other buttons 34ₙ of message board 30ₙ. If network server 16ₙ of system 10 were to be embodied as a search engine (see, for example, FIGS. 5a & 5b) user 24ₙ posted links 32ₙ may be made available within a results screen of a search engine website 12ₙ after a search has been performed, i.e. similar to the provision of sponsored links provided within a search engine website 12ₙ. Alternatively, a button (not shown) could appear within message board 30ₙ, or within a web-browser GUI 26ₙ (see below), that when pressed, would display the list of user 24ₙ links 32ₙ related to a particular website 12ₙ being viewed.

In accordance with a further present embodiment, and unique aspect, of the present invention (not shown) system 10 may enable users 24ₙ to access a facility (not shown) separate to message board 30ₙ (but possibly similar thereto) that allows them to add hyper-links 32ₙ to a list of multiple links 32ₙ related to a website 12ₙ they are viewing. This facility (not shown) could be accessed from within message board 30ₙ of system 10, or alternatively, could be accessed independent of message boards 30ₙ using a web-browser GUI 26ₙ based button or plug-in (not shown) that when pressed displays the list of linked sites 32ₙ without a message board 30ₙ being displayed.

By allowing users 24ₙ of system 10 to post links 32ₙ to related websites 12ₙ, other users 24ₙ of system 10 can use message boards 30ₙ as a means of finding interesting and/or related websites 12ₙ that they may not have otherwise located by way of conventional web-searching. For example, a user 24ₙ whilst viewing a mountain bike website 12ₙ may choose to add a link 32ₙ to a mountain bike club or a bike helmet supplier. In this way, a future user 24ₙ of system 10 would be presented with these links 32ₙ within message board 30ₙ, and hence, may choose to review the network content 12ₙ available at those links 32ₙ.

In order to provide a means of filtering and/or controlling the display of user generated content 32ₙ within message boards 30ₙ, system 10 may utilise a suitable rating system (not shown) that would allow users 24ₙ to rate and/or determine the quality of individual user generated content 32ₙ posted on message boards 30ₙ. A suitable system could be a star rating system that allocates a selected number of stars to user generated content 32ₙ within a range of available stars, as for example, a five star rating system. System 10 could aggregate ratings or votes received from users 24ₙ of system 10 and then allocate an average star rating for each user 24ₙ, or their individual user generated content 32ₙ. This rating would help users 24ₙ to assess the value of each users 24ₙ comments, links, etc. For example, a user 24ₙ that consistently posts helpful and insightful comments, would have a higher average star rating than those that post unconstructive comments.

In order to ensure that the rating allocated to a user 24ₙ of system 10, or their user generated content 32ₙ, is an accurate reflection of other users 24ₙ opinions, it may be necessary for system 10 to block users 24ₙ from submitting ratings for themselves, or their own user generated content 32ₙ.

Although the use of a star rating system has been proposed, wherein one star would represent the lowest rating and five stars would represent the highest rating, it should be appreciated that system 10 of the present invention is not limited to this specific example of a rating system. Many variations of suitable rating systems exist, such as, for example, a rating system that ranks users 24ₙ, or user generated content 32ₙ, out of 10, or even a simple two button like/dislike rating system, etc, and as such, these variations are intended to be included within the scope of the present application.

In terms of users 24ₙ utilising message boards 30ₙ as a means of posting links 32ₙ to related websites 12ₙ of interest, a rating system would enable other users 24ₙ to rate the quality and/or helpfulness of those links 32ₙ. If the link 32ₙ rating system (not shown) of system 10 was a voting system, system 10 may allocate a ranking to each link 32ₙ for each website 12ₙ and in doing so, may control where each link 32ₙ appears in the list of related sites provided within a message board 30ₙ, or separate link-sites GUI 26ₙ (not shown).

The actual positioning of user generated content 32ₙ, determined by a rating system (not shown) is preferably sequential, i.e. ordered from most popular to least popular, but it is envisaged that other methods could be utilised to visually demonstrate the relationship between threads, links 32ₙ, etc, and the primary website 12ₙ being viewed. In the case of user 24ₙ posted links 32ₙ, such an alternative system (not shown) could include a visual map that displays the most popular links 32ₙ that are considered to be the most closely related to the website 12ₙ, with the less popular, or least related, links 32ₙ being further away.

Aside from posting threads, attachments, links, etc, 32ₙ that are directly related to specific network content 12ₙ, users 24ₙ may also use message boards 30ₙ to interact and chat with one another regarding matters that are not directly, or at all, related to the network content 12ₙ displayed simultaneously with that message board 30ₙ. For example, a user 24ₙ utilising a message board independently associated with a website 12ₙ selling mountain bikes may use that message board 30ₙ to inform other users 24ₙ of their own personal mountain biking experiences.

Although not shown in the drawings, message boards 30ₙ may provide users 24ₙ with a private messaging facility that would allow them to send private messages to one another, without having to utilise their own personal e-mail address. The provision of such a facility (not shown), would allow users 24ₙ to click on other users 24ₙ usernames within message board 30ₙ in order to send them private messages utilising an in-built (not shown) e-mail system, i.e. each user 24ₙ would be provided with an inbox that they could routinely review upon logging in to use system 10. By clicking on an individual message within an inbox, users 24ₙ would be able to send replies to users 24ₙ from which messages have been received. This functionality will allow users 24ₙ to engage in a private dialogue. Upon a message being sent to a user 24ₙ, that user 24ₙ may also be sent a system 10 generated email (utilising a valid e-mail address), notifying them that another user 24ₙ has sent them a private message. This notification (system 10 generated) email may include a link that takes the user 24ₙ directly back to their personal inbox page within system 10. In accordance with usual web-based systems, users 24ₙ may be offered the opportunity to opt out of receiving private and/or system 10 generated messages.

Although specific examples of the features, construction, use and/or functionality of message boards 30ₙ of the present invention have been provided, it should be appreciated that the present invention is not limited to those examples only. A person skilled in the relevant art would appreciate the general operation and functionality of an online forum facility, and accordingly, would understand many alternative embodiments of such a facility. The present invention should therefore be construed as including within its scope any such alternative embodiments that would be deemed appropriate by a person skilled in the relevant art.

### User Database:

User database 20₃ stores personal and public information of users 24ₙ of system 10. During a sign-up or registration process, or when updating their profile information utilising, for example, user administration engine 18₂ users 24ₙ may select whether particular aspects (e.g. their name or nickname) of their profile are to be shared with other users 24ₙ of system 10.

### Forum Facility Display Engine:

Forum facility display engine 18₁ is a structured application that enables users 24ₙ of system 10 to evaluate WWW content 12ₙ by selectively choosing to simultaneously display that WWW content 12ₙ side-by-side with an independently associated message board 30ₙ.

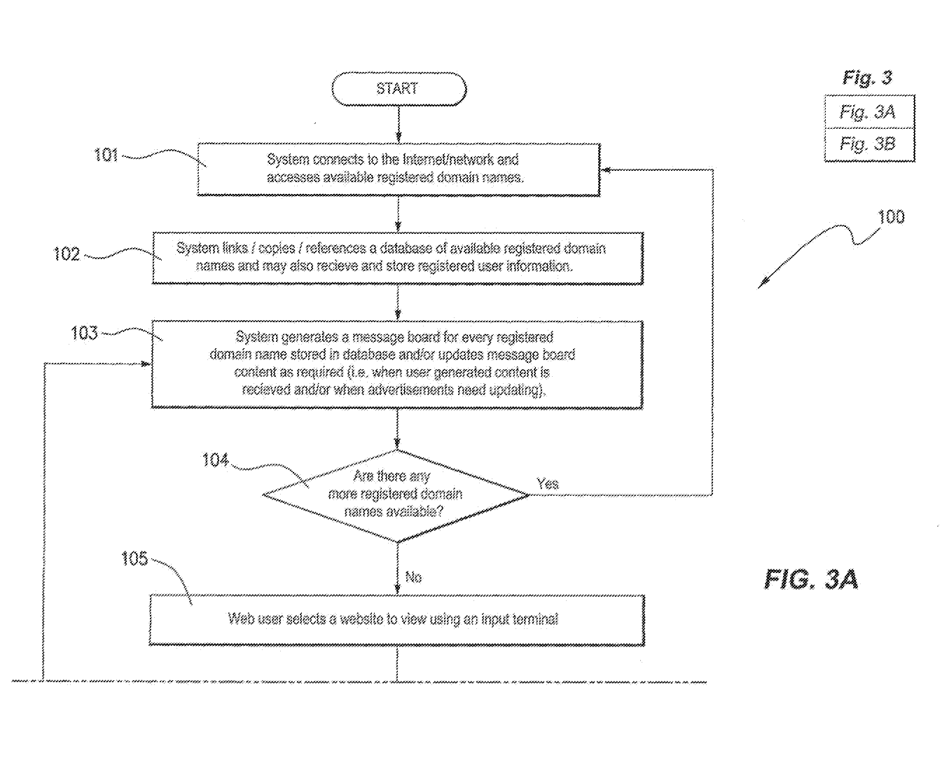

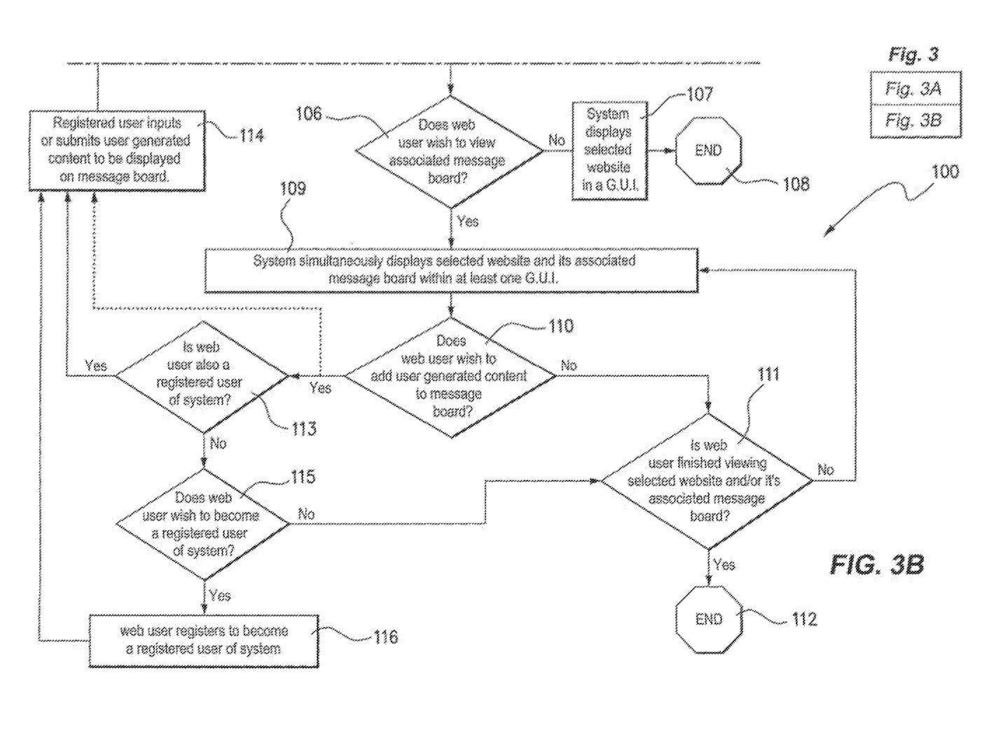

A flow diagram illustrating a preferred method 100 for evaluating WWW content 12ₙ in accordance with forum facility display engine 18₁ is shown in FIGS. 3a & 3b, with the flow diagram starting in FIG. 3a and continuing to FIG. 3b as shown. Method 100 of FIGS. 3a & 3b is suitable for use with system 10 of FIG. 1. It should be understood that the embodiment provided in FIGS. 3a & 3b only illustrates one way in which message boards 30ₙ may be selectively displayed simultaneously with the display of WWW content 12ₙ in accordance with system 10. Many other methods (not shown) may be utilised to achieve the same or similar result and as such the present invention is not limited to the specific example provided.

Method 100 of FIGS. 3a & 3b will be described in conjunction with FIGS. 1 & 2. In FIG. 2, GUI 26ₙ is a web-browser GUI. It should be appreciated that any suitable GUI 26ₙ can be used depending on the application of system 10, and the way in which message boards 30ₙ of system 10 are accessible via the Internet 14ₙ to users 24ₙ stationed at input terminals 22ₙ. Similarly, the content of GUI 26ₙ shown in FIG. 2 only represents an example of the type of information that can be simultaneously displayed to users 24ₙ of system 10. Accordingly, the present invention should not be construed as being limited to any of the specific examples provided.

Referring to FIGS. 3a & 3b, method 100 for evaluating WWW content 12ₙ in accordance with forum facility display engine 18₁ starts at block 101, wherein network server 16ₙ of system 10 queries the Internet 14ₙ at predetermined intervals to locate available registered domain names. If available registered domain names are located, at block 102, network server 16ₙ acquires and stores details pertaining to those available registered domain names in network address database 20₁.

After locating and storing details of available registered domain names in network address database 20₁, at block 103, network server 16ₙ generates a message board 30ₙ for each of the available registered domain names stored in network address database 20₁ (preferably all available registered domain names). Data pertaining to these generated message boards 30ₙ is stored by network server 16ₙ in forum facility database 20₂.

Decision block 104, illustrates that network server 16ₙ of system 10 continues to query the Internet 14ₙ at predetermined intervals to ensure that message boards 30ₙ for all (or at least as many as possible) available registered domain names are available to users 24ₙ of system 10.

Block 105 illustrates the first point of interaction of a user 24ₙ with system 10, whereat a user 24ₙ has selected WWW content 12ₙ available at a specific registered domain name to review utilising an input terminal 22ₙ. Referring to FIG. 2, it can be seen that user 24ₙ has entered a registered domain name (or a URL of a predetermined format having the selected registered domain name contained therein—as explained in further detail later in this specification) directly into the URL field 44 provided within web-browser GUI 26ₙ. After pressing ENTER on a keyboard 46 connected to input terminal 22ₙ, or clicking on the retrieve URL or GO button 48 provided within web-browser GUI 26ₙ, a request is sent to network server 16ₙ, via the Internet 14ₙ, to initiate the process of selectively and simultaneously displaying the message board 30ₙ independently associated with that WWW content 12ₙ.

After a request is received by network server 16ₙ of system 10, at decision block 106, user 24ₙ may be prompted as to whether they would like to view the message board 30ₙ available for the selected WWW content 12ₙ. If at block 106 user 24ₙ declines to view message board 30ₙ, only the selected WWW content 12ₙ is displayed within web-browser GUI 26ₙ, as is indicated by block 107. If after reviewing the selected WWW content 12ₙ at block 107, user 24ₙ chooses to continue to only view WWW content 12ₙ, and not message boards 30ₙ independently associated with WWW content 12ₙ, method 100 concludes at block 108.

If at decision block 106, user 24ₙ chooses to view message board 30ₙ, method 100 continues at block 109, whereat the selected WWW content 12ₙ and its independently associated message board 30ₙ are simultaneously displayed within web-browser GUI 26ₙ, as is shown in FIG. 2. User 24ₙ is then able to review threads 32ₙ (or other user generated content 32ₙ) posted on that message board 30ₙ to help them make an informed decision regarding the selected WWW content 12ₙ.

At decision block 110, user 24ₙ can decide, or may be prompted, as to whether they would like to post their own user generated content 32ₙ, e.g. threads, links, etc, on message board 30ₙ.

If at block 110, user 24ₙ declines to post their own threads 32ₙ on message board 30ₙ, at decision block 111 a check may be made to see whether user 24ₙ is finished reviewing the selected WWW content 12ₙ and its independently associated message board 30ₙ. If at block 111, user 24ₙ is not finished reviewing WWW content 12ₙ and message board 30ₙ, method 100 returns to block 109, wherein the simultaneous display of WWW content 12ₙ and message board 30ₙ is maintained. If at block 111, user 24ₙ is finished reviewing WWW content 12ₙ and message board 30ₙ, method 100 concludes at block 112.

If at decision block 110, user 24ₙ chooses to post their own user generated content 32ₙ (e.g. threads 32ₙ, etc) on message board 30ₙ, method 100 may continue at decision block 113, or block 114, depending on whether forum facility display engine 18₁ of system 10 utilises a user administration engine 18₂ in order to police the usage of system 10.

If forum facility display engine 18₁ of system 10 does not utilise a user administration engine 18₂, method 100 continues at block 114, whereat user 24ₙ can input user generated content 32ₙ (or threads 32ₙ, etc) to be posted on message board 30ₙ. After inputting a thread(s) 32ₙ, etc, at block 114, method 100 returns to block 103, whereat network server 16ₙ of system 10 (possibly selectively) stores that user generated content 32ₙ in forum facility database 20₂, and subsequently posts that user generated content 32ₙ on message board 30ₙ. Method 100 then continues as before until such a time that user 24ₙ wishes to stop simultaneously viewing selected WWW content 12ₙ and its independently associated message boards 30ₙ (i.e. ends at block 112).

If forum facility display engine 18₁ of system 10 does utilise a user administration engine 18₂, method 100 continues at decision block 113, whereat a check is made as to whether user 24ₙ is a registered user 24ₙ of system 10, and/or is signed-in to use system 10, in order to post threads 32ₙ, etc, on message boards 30ₙ. If user 24ₙ is a registered user 24ₙ, and/or is signed-in to use system 10, method 100 continues at block 114, whereat, like before, user 24ₙ can input user generated content 32ₙ or threads 32ₙ to be posted on message board 30ₙ. However, if at block 113 it is determined that user 24ₙ is not a registered user 24ₙ of system 10, and/or is not signed-in to use system 10, method 100 continues at decision block 115, whereat user 24ₙ is prompted as to whether they would like to register and/or sign-in to post threads 32ₙ, etc, on message boards 30ₙ of system 10.

If at decision block 115, user 24ₙ declines to register and/or sign-in to use system 10, method 100 continues at block 111, whereat, like before, the use of system 10 either ends (block 112) or returns to block 109, at which point the simultaneous display of the selected WWW content 12ₙ and its independently associated message board 30ₙ is maintained.

If at decision block 115, user 24ₙ chooses to register and/or sign-in to use system 10, method 100 continues at block 116, whereat user 24ₙ may register to use system 10, and/or sign-in to system 10, in order to post threads 32ₙ, etc, on message boards 30ₙ of system 10. After registering and/or signing-in at block 116, method 100 continues at block 114, whereat, like before, user 24ₙ can input user generated content 32ₙ or threads 32ₙ to be posted on message board 30ₙ.

Although not specifically shown in FIGS. 3a & 3b, method 100 may also include an additional block or step (not shown) of checking user generated content 32ₙ for suitability and/or appropriateness utilising, for example, UGC administration engine 18₃ of system 10.

### User Administration Engine:

As already briefly described above with reference to forum facility display engine 18₁, user administration engine 18₂ is a structured application that may be utilised by network server 16ₙ to police the use of system 10. User administration engine 18₂ may be used at blocks 113 to 116 of preferred method 100 of FIGS. 3a & 3b, to control access to the posting of threads 32ₙ, or other user generated content 32ₙ, on message boards 30ₙ of system 10.

In accordance with a preferred embodiment of the present invention, during the registration and/or sign-in process of system 10 (block 116 of FIGS. 3a & 3b), users 24ₙ must agree to predetermined acceptable Terms of Use before they can post threads 32ₙ, etc, on message boards 30ₙ of system 10. The predetermined Terms of Use may simply be an extension of related Terms of Use for other website usage, such as, for example, a search engine.

The registration and/or sign-in process of system 10 may also require: a valid e-mail address; IP logging within each session; and/or, the use of suitable security certificates which must be installed locally on input terminals 22ₙ before users 24ₙ are able to post user generated content 32ₙ on message boards 30ₙ. Cookies could be used to automatically sign-in a user 24ₙ to system 10 after the registration process has been successfully completed.

If an e-mail address is required during the registration process, registered users 24ₙ may choose to select whether they wish to receive messages or e-mails from other users 24ₙ regarding their posts (threads 32ₙ, etc). Should a registered user 24ₙ choose to receive messages from other users 24ₙ, system 10 may automatically send an e-mail to that user 24ₙ upon another user 24ₙ wishing to respond to that users 24ₙ posts 32ₙ. The actual e-mail address would most likely not be displayed to the other user 24ₙ for security/privacy reasons.

In an alternative embodiment, and as briefly described above with reference to forum facility database 20₂, should system 10 provide a private messaging facility within message boards 30ₙ, a valid e-mail address need not be required in order for users 24ₙ to receive e-mails or messages from other users 24ₙ of system 10. In such an alternative embodiment, message boards 30ₙ may simply provide all users 24ₙ with an inbox (not shown) that they can routinely check to see if e-mails have been received from other users 24ₙ of system 10.

In either, or both embodiments, e-mails sent by system 10, or users 24ₙ, may include a link to the relevant message board 30ₙ so that the user 24ₙ could then view other/new threads 32ₙ posted thereon. This functionality of system 10 may help to drive users 24ₙ back to message boards 30ₙ, and may entice them to post further threads 32ₙ, to ensure that the message boards 30ₙ remain fresh and/or up to date.

UGC Administration Engine: As already briefly described above with reference to forum facility display engine 18₁, UGC administration engine 18₃ is a structured application that may be utilised by network server 16ₙ to administer the content of threads 32ₙ, etc, posted on message boards 30ₙ of system 10. UGC administration engine 18₃ may be used by system 10 to block posting of certain types of user generated content 32ₙ on message boards 30ₙ, and/or may be used to remove particular user generated content 32ₙ from message boards 30ₙ should objections regarding the content thereof be received from other users 24ₙ, or individuals having reason to question that content.

### Advertising Engine:

Advertising engine 18₄ is a structured application that can be used to automatically place and maintain advertisements, and/or sponsored links, etc, within the advertising spaces 42ₙ provided within message boards 30ₙ of system 10.

A person skilled in the relevant art would appreciate many ways in which advertisements, etc, can be placed within advertising spaces 42ₙ provided within GUI's 26ₙ, and as such, a detailed discussion of same will not be provided herein. The present invention should be construed as including within its scope any suitable means of placing advertisements, etc, within advertising spaces 42ₙ of message boards 30ₙ, within a GUI 26ₙ.

The placement of advertisements within advertising spaces 42ₙ of message boards 30ₙ can be used to create competition when viewing WWW content 12ₙ, e.g. a competitor can purchase that advertising space 42ₙ. Thus system 10 provides a unique opportunity for advertisers to reach their competitors customers directly, i.e. by purchasing the/an advertising space 42ₙ available on a message board 30ₙ independently associated with their competitor's website 12ₙ.

This type of target marketing/advertising is believed to have not before been provided on the internet 12ₙ.

As the content of message boards 30ₙ continually changes with each and every user post (e.g. thread 32ₙ), advertising engine 18₄ of system 10 may also update the advertisements and/or sponsored links displayed within an advertising space 42ₙ provided on a message board 30ₙ, or within a search engine results screen (see for example FIGS. 5a & 5b) incorporating the invention, based on the content of user posts 32ₙ.

As the use of system 10 grows, the user generated content 32ₙ posted on message boards 30ₙ and stored in forum facility database 20₂ will grow enormously. This will enable advanced data mining techniques to be used to improve target advertisements. Both the message boards 30ₙ, and/or their corresponding WWW content 12ₙ, could be mined to continually update the advertisements and/or sponsored links that are displayed within advertising spaces 42ₙ of message boards 30ₙ. This type of data mining would provide a level and type of targeting advertising delivery not before been achievable.

Aside from using advertising spaces 42ₙ in accordance with conventional advertising techniques, advertising spaces 42ₙ of message boards 30ₙ of the present invention may also provide a convenient location to include, and hence run, promotional offers, e.g. sales promotional offers, within message boards 30ₙ. For example, coupon or rebate type sales promotions could be offered to users 24ₙ within message boards 30ₙ of system 10.

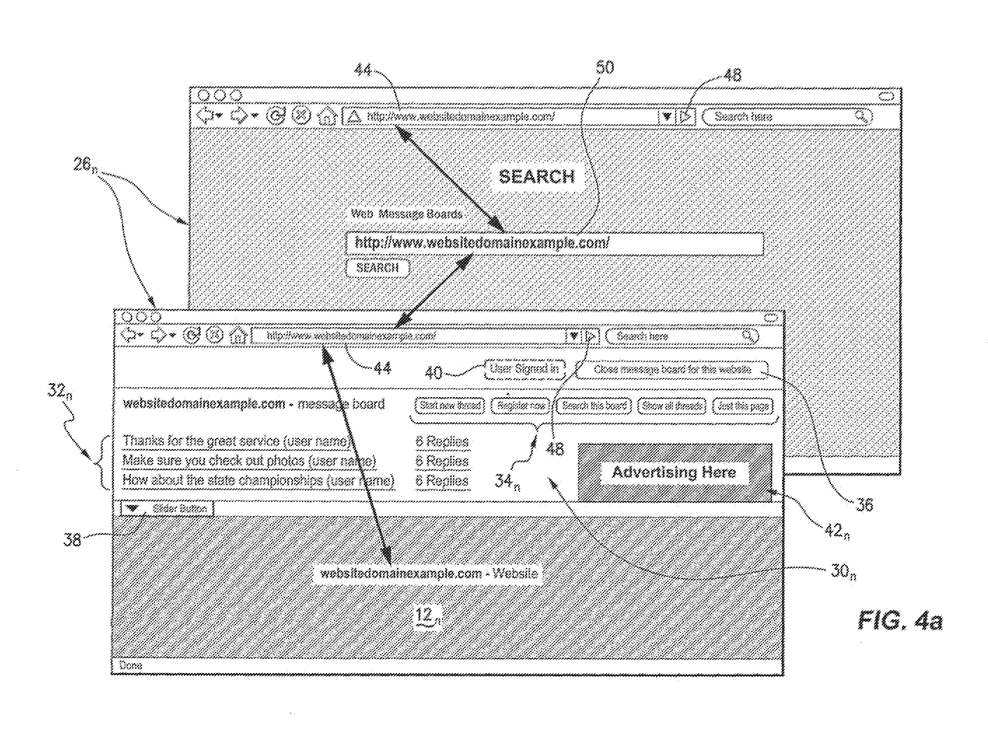

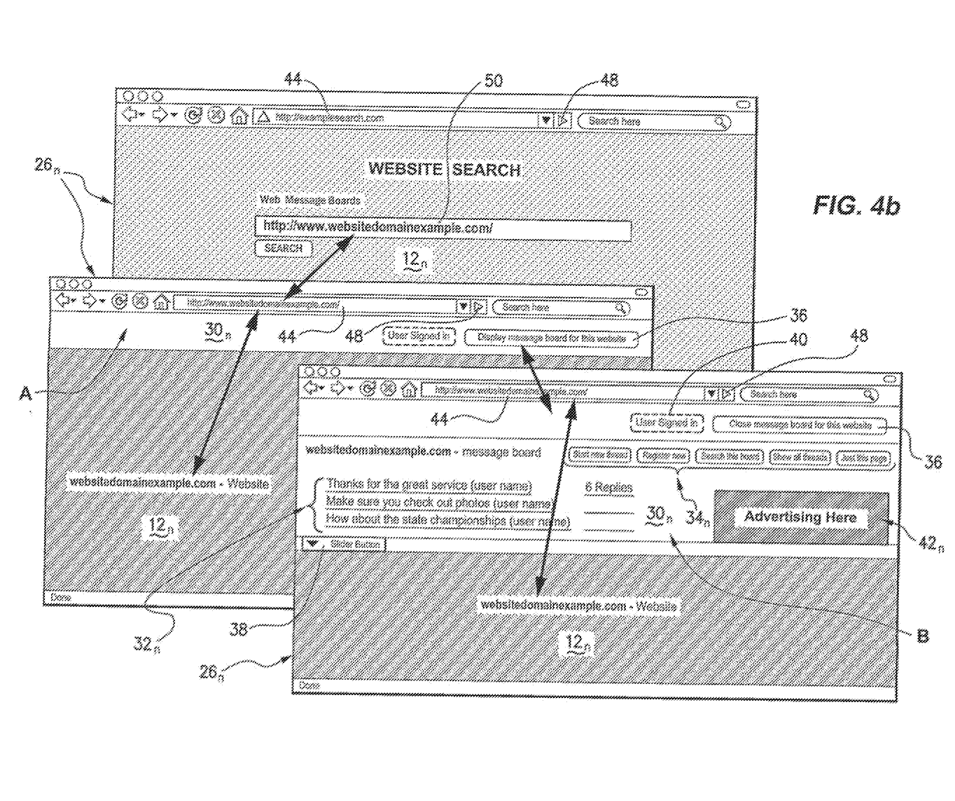

To provide a better understanding of the operation of system 10, a number of examples of possible uses of system 10 will now be described with reference to FIGS. 4a to 8. It should be appreciated that the examples that follow only represent a portion of the possible uses of system 10 and as such the present invention should not be construed as limited to those examples provided.

Entering a Registered Domain Name Directly into a GUI or a Website:

In FIGS. 4a & 4b there are shown exemplary GUI's 26ₙ, which illustrate preferred examples of the use of system 10 of FIG. 1, wherein it can be seen that a user 24ₙ is able to simultaneously view a website 12ₙ and its independently associated message board 30ₙ by entering a selected registered domain name directly into a URL field 44 or a search field 50 built into a web-browser GUI 26ₙ (FIG. 4a), or a search field 50 provided on a website 12ₙ displayed within a web-browser GUI 26ₙ (FIG. 4b).

In the example shown in FIG. 4a, web-browser GUI 26ₙ may require a suitable (purpose-built) plug-in, or add-on, in order to enable the web-browser to determine that for all selected registered domain names that are entered directly into URL field 44, or search field 50, it is to simultaneously display the selected WWW content 12ₙ and its independently associated message board 30ₙ. In an alternative embodiment (not shown), instead of utilising a browser plug-in, users 24ₙ of system 10 may be required to enter the selected registered domain name into the URL 44 or search field 50 of the web-browser GUI 26ₙ in a specific format which may include the URL address (i.e. the registered domain name) of network server 16ₙ (not shown). In this way, the selected registered domain name could be conveniently passed to network server 16ₙ as part of the text that is entered into the URL 44, or search field 50, of web-browser GUI 26ₙ by a user 24ₙ.

In one embodiment of the examples shown in FIGS. 4a & 4b, network server 16ₙ (not shown) of system 10 may be a dedicated network content evaluation server 16ₙ which may be used by users 24ₙ to simultaneously display WWW content 12ₙ available at the registered domain name entered directly into the URL or search fields 44,50 of web-browser GUI 26ₙ (FIG. 4a), or the search field 50 of website 12ₙ displayed within web-browser GUI 26ₙ (FIG. 4b), and its independently associated message board 30ₙ.

In an alternative embodiment of the example shown in FIG. 4b, network server 16ₙ (not shown) of system 10 may be a search engine, and hence, the website 12ₙ displayed within web-browser GUI 26ₙ in this figure may simply be the search or home page 12ₙ of that search engine (i.e. network server 16ₙ). In this way, and in accordance with a further preferred aspect of the present invention, the search field 50 of website 12ₙ shown displayed within web-browser GUI 26ₙ of FIG. 4b, may be used as conventional, i.e. in order to perform ‘keyword-based’ web-searches (see FIGS. 5a & 5b), or may be used in a novel way in accordance with the invention to automatically and simultaneously display WWW content 12ₙ available at the selected registered domain name entered into the website search field 50, of website 12ₙ, and its independently associated message board 30ₙ.

In FIG. 4a, message board 30ₙ is shown in its expanded state, positioned above WWW content 12ₙ (i.e. website 12ₙ) within a single web-browser GUI 26ₙ. Whilst, in FIG. 4b, it is shown that message board 30ₙ can be initially displayed in a collapsed state (see item A), and may then be selectively extended to its expanded state (see item B) upon a user 24ₙ clicking on, for example, open/close message board button 36, and/or by utilising slider button 38 to selectively adjust the desired amount of message board 30ₙ that is displayed within web-browser GUI 26ₙ. In this way, should a user 24ₙ not wish to view message board 30ₙ, they need not do so by not extending message board 30ₙ to its expanded state B.

Clicking on a Hyper-Link or Button within a Search Engine Results Screen:

In FIGS. 5a & 5b there are shown exemplary GUI's 26ₙ, which illustrate further preferred examples of the use of system 10 of FIG. 1. In these examples, network server 16ₙ is a search engine, and it can be seen that a user 24ₙ is able to simultaneously view a website 12ₙ and its independently associated message board 30ₙ by clicking on a hyper-link 52ₙ, or button 54ₙ, provided within a results screen 12ₙ of search engine 16ₙ after a keyword-based web-search has been performed.

Like in the case of FIG. 4a, in FIG. 5a, message board 30ₙ is shown in its expanded state, positioned above website 12ₙ within a single web-browser GUI 26ₙ. Whilst, in FIG. 5b (like in the case of FIG. 4b), it is shown that message board 30ₙ can be initially displayed in a collapsed state (see item A), and may then be selectively extended to its expanded state (not shown) upon a user 24ₙ clicking on, for example, open/close message board button 36 of message board 30ₙ. In this way, should a user 24ₙ not wish to view message board 30ₙ, they need not do so by not extending message board 30ₙ by way of open/close button 36, etc.

Clicking on a Web-Link or Sponsored Web-Link within a Website:

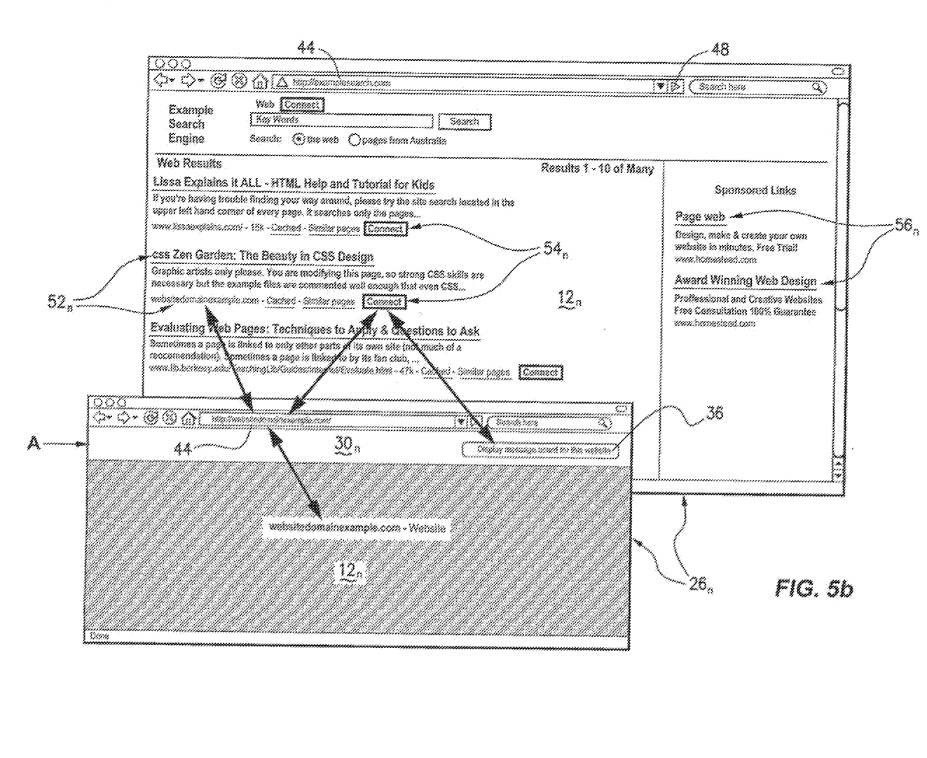

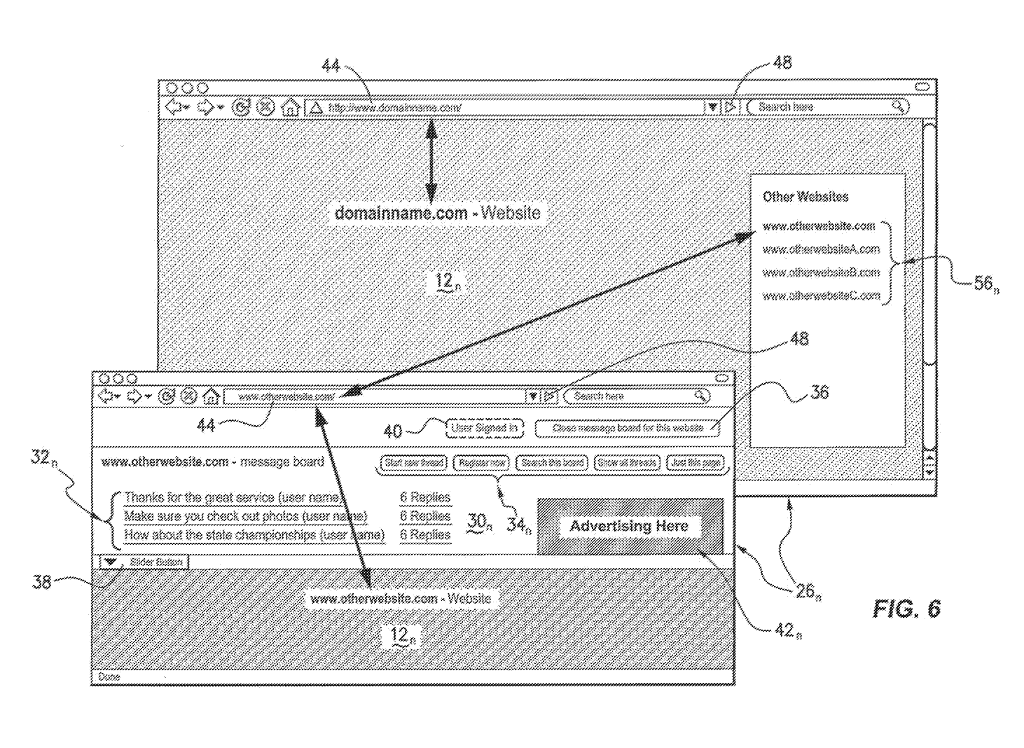

In FIG. 6 there is shown an exemplary GUI 26ₙ, which illustrates a further preferred example of the use of system 10 of FIG. 1. In this example, network server 16ₙ may be a search engine, or a dedicated network content evaluation server 16ₙ, and it can be seen that a user 24ₙ is able to simultaneously view a website 12ₙ and its independently associated message board 30ₙ by clicking on a web-link or sponsored web-link 56ₙ provided within a results screen of search engine 16ₙ after an Internet search has been performed, or provided within a website 12ₙ (should network server 16ₙ be a dedicated network content evaluation server 16ₙ).

### Using a Web-Browser GUI Plug-in or Toolbar:

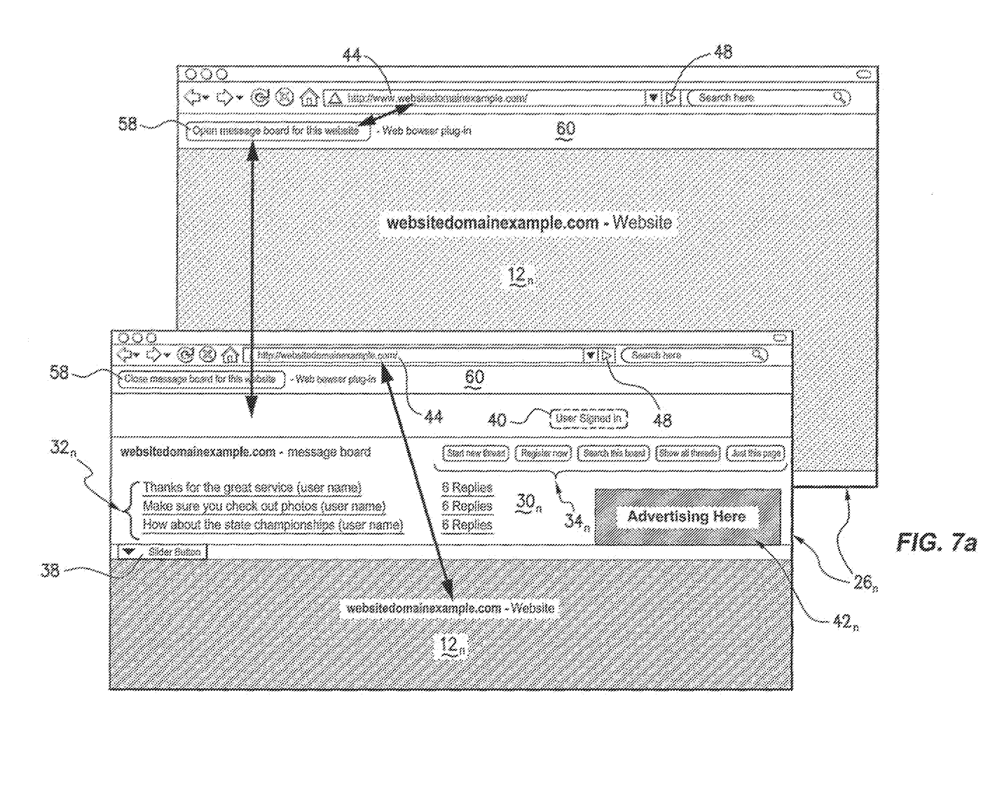

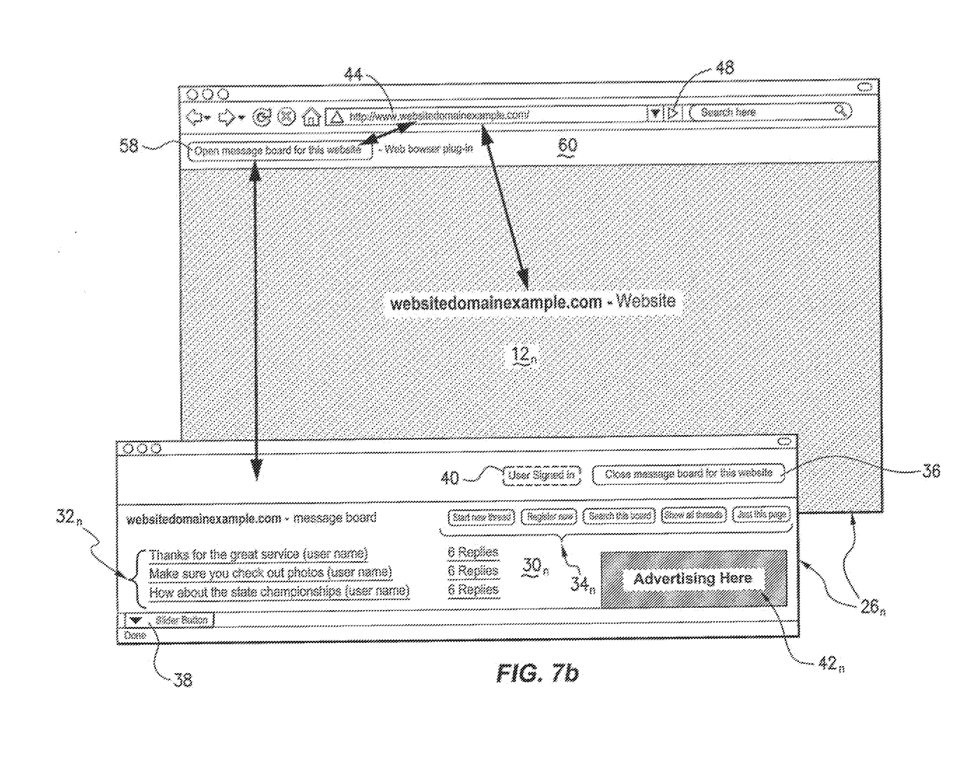

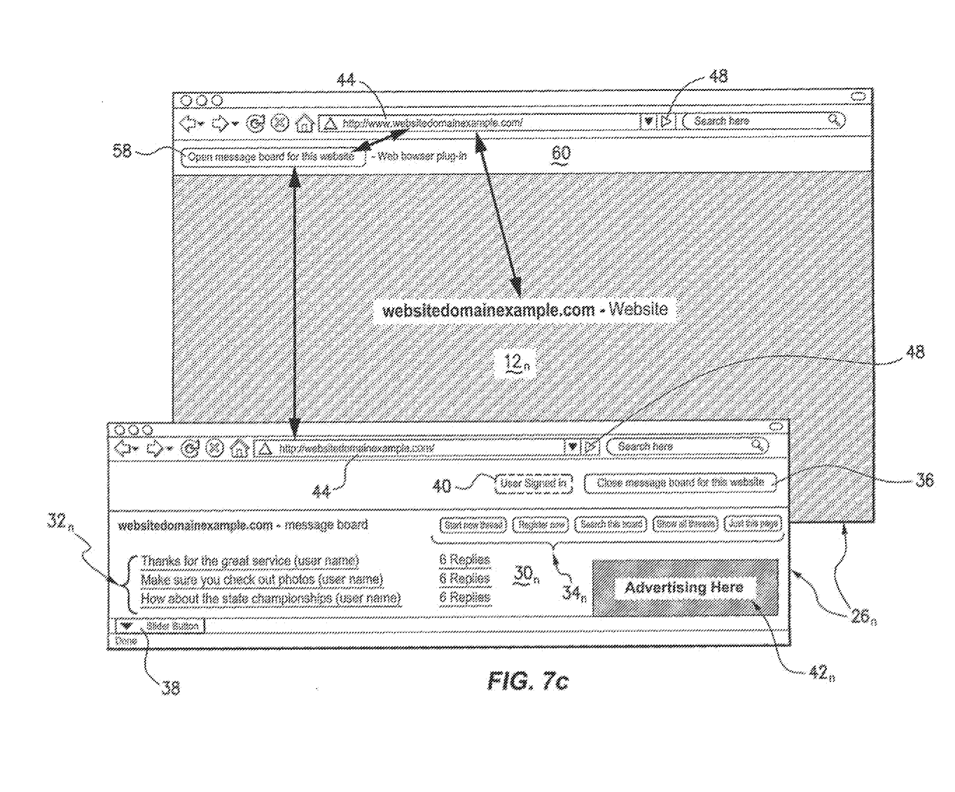

In FIGS. 7a to 7c there are shown exemplary GUI's 26ₙ, which illustrate further preferred examples of the use of system 10 of FIG. 1. In these examples, network server 16ₙ may be a search engine, or a dedicated network content evaluation server 16ₙ, and it can be seen that a user 24ₙ is able to simultaneously view a website 12ₙ and its independently associated message board 30ₙ by clicking on a plug-in button 58 provided on a web-browser GUI 26ₙ plug-in or tool bar 60 when a selected website 12ₙ is displayed within web-browser GUI 26ₙ. In this way message board 30ₙ can be selectively displayed at any time upon a user 24ₙ choosing to click on plug-in button 58. The use of toolbar 60 may minimise the steps required to view a message board 30ₙ.

In FIG. 7a, like in the case of FIGS. 4a, 5a & 6, message board 30ₙ is shown in its expanded state, positioned above website 12ₙ within a single web-browser GUI 26ₙ. In FIGS. 7b & 7c, it is shown that message boards 30ₙ can also be displayed in separate pop-up windows (FIG. 7b), or in separate web-browser GUI's 26ₙ (FIG. 7c). Although not shown in FIGS. 7a to 7c, it will be appreciated that message boards 30ₙ may be expanded and/or collapsed utilising open/close message board button 36, slider button 38, or plug-in button 58 of toolbar 60, depending on a users 24ₙ preference. Similarly, although not shown in FIG. 7a or 7c, message board 30ₙ may be displayed on a separate tab (not shown) provided within a web-browser GUI 26ₙ.

### Using a Dedicated Message Board GUI Application:

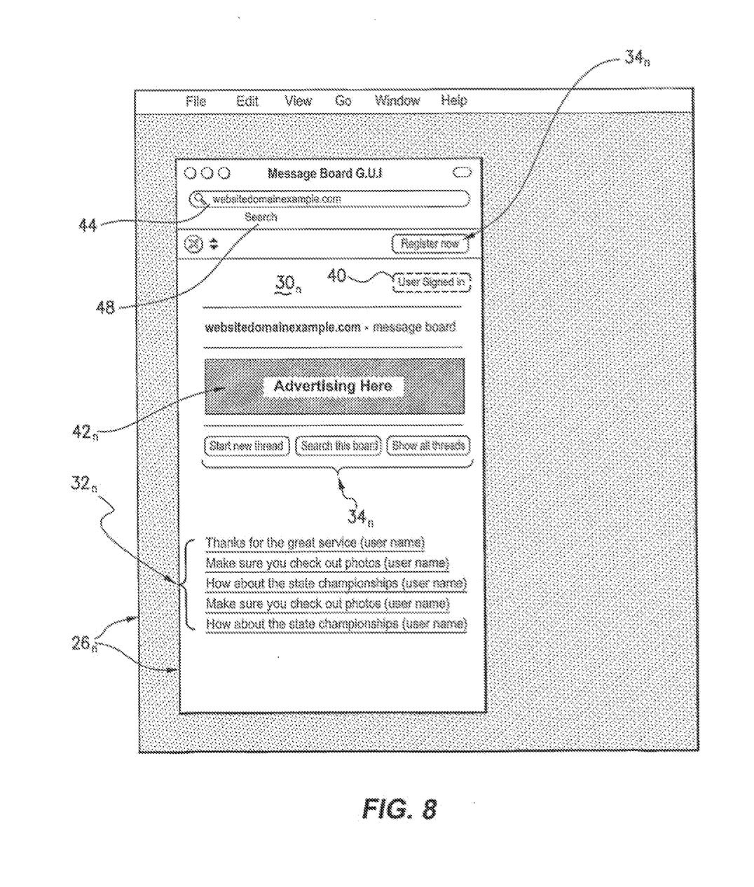

In FIG. 8 there is shown an exemplary GUI 26ₙ, which illustrates a further preferred example of the use of system 10 of FIG. 1. In this example, network server 16ₙ may be a search engine, or a dedicated network content evaluation server 16ₙ, and it can be seen that a user 24ₙ is able to simultaneously view a website (not shown) and its independently associated message board 30ₙ utilising two separate GUI 26ₙ applications. A first of these two GUI's 26ₙ may be a web-browser GUI (not shown), or any other suitable GUI 26ₙ, for displaying selected WWW content (not shown), whilst a second of these two GUI's 26ₙ is dedicated message board GUI 26ₙ for displaying independently associated message boards 30ₙ therein. In this example, users 24ₙ may selectively use both of these GUI's 26ₙ to simultaneously display selected WWW content 12ₙ and its independently associated message board 30ₙ.

Message board GUI 26ₙ may operate as an executable installed locally on an input terminal 22ₙ, wherein a user 24ₙ could select a website 12ₙ to view utilising the first GUI 26ₙ (not shown), and then could retrieve and simultaneously display its independently associated message board 30ₙ utilising message board GUI 26ₙ.

These examples therefore demonstrate that system 10 provides users 24ₙ with a novel means of evaluating WWW content 12ₙ for the purpose of making an informed decision regarding that content 12ₙ.

The present invention therefore provides a system 10 and/or method 100 which enables network content 12ₙ, preferably WWW content 12ₙ, to be evaluated over a network 14ₙ, preferably the Internet 14ₙ. In accordance with the present invention, network content 12ₙ is simultaneously displayed side-by-side with an independently associated message board 30ₙ. The message boards 30ₙ provide an interactive forum facility which enables the creation of an online community of network content 12ₙ conscience individuals who are dedicated to the interactive exchange of opinions and/or information that other network users 24ₙ can utilise to help them make informed decisions regarding network content 12ₙ.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

Finally, as the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and the appended claims. Therefore, the specific embodiments are to be understood to be illustrative of the many ways in which the principles of the present invention may be practiced.

1. A method for evaluating network content over a communications network, said method comprising the steps of:
providing at least one network server which stores or maintains a plurality of forum facilities, each of said forum facilities being paired with a specific network location that contains network content that is independent of said at least one network server;
querying said communications network at predetermined intervals to locate available network locations;
acquiring and storing details of at least selected ones of said available network locations in at least one repository associated with said at least one network server;
generating and pairing a said forum facility with each of said available network locations for which details were acquired and stored in said at least one repository;
providing at least one user operable terminal with controlled access to said at least one network server and said forum facilities stored thereon;
receiving and processing at said at least one network server a request sent from said at least one user operable terminal, via said communications network, to view or acquire network content from a selected network location; and
displaying or providing said network content on or to said at least one user operable terminal whilst simultaneously displaying said forum facility paired with said selected network location.

2. The method as claimed in claim 1, further comprising the steps of:
receiving user generated content from at least one of said user operable terminals, via at least one of said forum facilities, regarding network content available at selected network locations;
storing said user generated content on said at least one network server;
selectively updating said at least one of said forum facilities with said user generated content relative thereto; and
making said forum facilities available to all of said user operable terminals;
wherein said user generated content enables users of said at least one user operable terminals to evaluate network content available at said selected network locations.

3. The method as claimed in claim 2, wherein said user generated content includes at least one selected from the group consisting of threads, hyper-links, file attachments, embedded video, images, and sound files.

4. The method as claimed in claim 2, wherein users are provided with a means of rating said user generated content such that said at least one network server can utilize user ratings received in order to determine order of display of said user generated content within said forum facilities.

5. The method as claimed in claim 1, wherein said at least one network server is at least one computing device which includes at least one processor which is operable to execute software that maintains and controls access to said forum facilities for said user operable terminals.

6. The method as claimed in claim 5, wherein said at least one computing device is a web-server accessible to said at least one user operable terminal via said communications network, which is the Internet.

7. The method as claimed in claim 6, wherein users can access said web-server via at least one software application installed on said at least one user operable terminal which may be permanently, or selectively, connected to said Internet.

8. The method as claimed in claimed 7, wherein said network content is WWW (world-wide web) content and said network locations include registered domain names, and wherein each of said forum facilities are paired with a specific registered domain name containing said WWW content.

9. The method as claimed in claim 1, wherein said at least one user operable terminal is selected from the group consisting of a Personal Digital Assistant (PDA), a mobile phone, a cellular phone, a personal computer, a tablet computer, and a notebook computer.

10. The method as claimed in claim 8, further comprising the steps of:
querying said Internet at predetermined intervals to locate available registered domain names;
acquiring and storing at least selected ones of said available registered domain names in said at least one repository associated with said web-server; and
generating and pairing a said forum facility with each of said available domain names stored in said at least one repository.

11. The method as claimed in claim 8, wherein said web-server is a search engine and said at least one software application installed on said at least one user operable terminal is a web-browser GUI (graphical user interface).

12. The method as claimed in claim 11, wherein said request sent from said at least one user operable terminal to said search engine, via said Internet, is accomplished by said users clicking on hyper-links or buttons displayed within said web-browser GUI that are associated with selected registered domain names containing said WWW content that are displayed after a search has been performed.

13. The method as claimed in claim 11, wherein said request sent from said at least one user operable terminal to said search engine, via said Internet, is accomplished by said users entering a selected registered domain name directly into a search field provided by said search engine within said web-browser GUI.

14. The method as claimed in claim 8, wherein said web-server is a dedicated network content evaluation server which may be used by said users to simultaneously display said WWW content and said forum facilities paired therewith, and wherein said at least one software application installed on said at least one user operable terminal is a web-browser GUI.

15. The method as claimed in claim 14, wherein said request sent from said at least one user operable terminal to said dedicated network content evaluation server, via said Internet, is accomplished by said users entering a selected registered domain name directly into a search field built into said web-browser GUI, or a search field provided on a website displayed within said web-browser GUI.

16. The method as claimed in claim 8, wherein said WWW content and said forum facilities paired therewith may be simultaneously displayed by utilizing a web-browser GUI plug-in, including a toolbar or web-browser add-on.

17. The method as claimed in claim 8, wherein said web-server is a search engine or a dedicated network content evaluation server and said user operable terminals include two software applications installed thereon, a first of said two software applications being a web-browser GUI for displaying said WWW content, and a second of said two software applications being a dedicated forum facility GUI for displaying said forum facilities, and wherein said users may selectively use both of said software applications to simultaneously display said WWW content and said forum facilities paired therewith.

18. A system for evaluating network content, said system being operable over a communications network, said system comprising:
at least one network server including:
at least one memory or storage unit operable to store or maintain a plurality of forum facilities, each of said forum facilities being paired with a specific network location that contains network content that is independent of said at least one memory or storage unit; and
at least one processor operable to execute software that maintains and controls access to said forum facilities for a plurality of users; and
at least one input/output device operable to provide an interface for said plurality of users to operate said software in order to retrieve and view said forum facilities from said at least one memory or storage unit whilst simultaneously retrieving and viewing said network content from selected ones of said network locations via said communications network;
wherein said at least one network server queries said communications network at predetermined intervals to locate available network locations, acquires and stores details of at least selected ones of said available network locations in at least one repository associated with said at least one network server, and generates and pairs a said forum facility with each of said available network locations for which details were acquired and stored in said at least one repository; and
wherein said forum facilities stored and/or maintained on said at least one memory or storage unit include user generated content received from at least one of said plurality of users regarding network content available at selected ones of said network locations.

19. The system as claimed in claim 18, wherein said user generated content includes at least one selected from the group consisting of threads, hyper-links, file attachments, embedded video, images, and sound files.

20. The system as claimed in claim 18, wherein said plurality of users are provided with a means of rating said user generated content such that said system can utilize user ratings received in order to determine order of display of said user generated content within said forum facilities.

21. The system as claimed in claim 18, wherein said at least one network server is a web-server accessible to said plurality of users via said communications network, which is the Internet.

22. The system as claimed in claim 21, wherein said at least one input/output device is associated with at least one user operable terminal.

23. The system as claimed in claim 22, wherein each of said plurality of users can access said forum facilities stored or maintained on said web-server via at least one software application installed on said at least one user operable terminal which may be permanently, or selectively, connected to said Internet.

24. The system as claimed in claim 23, wherein said at least one user operable terminal is selected from the group consisting of a PDA, a mobile phone, a cellular phone, a personal computer, a tablet computer, and a notebook computer.

25. The system as claimed in claim 23, wherein said network content is WWW content and said network locations include registered domain names, and wherein said forum facilities are each paired with a specific registered domain name, containing said WWW content.

26. The system as claimed in claim 25, wherein said web-server queries said Internet at predetermined intervals to locate available registered domain names, acquires and stores at least selected ones of said available registered domain names in said at least one repository associated with said web-server, and generates and pairs a said forum facility with each of said available domain names stored in said at least one repository.

27. The system as claimed in claim 25, wherein said web-server is a search engine and said at least one software application installed on said at least one user operable terminal is a web-browser GUI.

28. The system as claimed in claim 27, wherein said plurality of users can simultaneously display said WWW content and said forum facilities paired therewith by clicking on hyper-links or buttons displayed within said web-browser GUI that are associated with selected registered domain names containing said WWW content that are displayed after a search has been performed.

29. The system as claimed in claim 27, wherein said plurality of users can simultaneously display said WWW content and said forum facilities paired therewith by entering a selected registered domain name directly into a search field provided by said search engine within said web-browser GUI.

30. The system as claimed in claim 25, wherein said web-server is a dedicated network content evaluation server which may be used by said plurality of users to simultaneously display said WWW content and said forum facilities paired therewith, and wherein said at least one software application installed on said at least one user operable terminal is a web-browser GUI.

31. The system as claimed in claim 30, wherein said plurality of users can simultaneously display said WWW content and said forum facilities paired therewith by entering a selected registered domain name directly into a search field built into said web-browser GUI, or a search field provided on a website displayed within said web-browser GUI.

32. The system as claimed in claim 25, wherein said WWW content and said forum facilities paired therewith may be simultaneously displayed by utilizing a web-browser GUI plug-in, including: a toolbar or web-browser add-on.

33. The system as claimed in claim 25, wherein said web-server is a search engine or a dedicated network content evaluation server and said user operable terminals include two software applications installed thereon, a first of said two software applications being a web-browser GUI for displaying said WWW content, and a second of said two software applications being a dedicated forum facility GUI for displaying said forum facilities, and wherein said users may selectively use both of said software applications to simultaneously display said WWW content and said forum facilities paired therewith.

34. A method for evaluating WWW content over the Internet, said method including the steps of:
querying the Internet at predetermined intervals to locate available registered domain names;
acquiring details pertaining to at least selected ones of said available registered domain names;
generating and pairing an independent forum facility with each of said available registered domain names for which details were acquired; and
selectively making said independent forum facilities available to WWW users for simultaneous display with said WWW content for the purpose of evaluating WWW content available at registered domain names paired therewith.

35. The method as claimed in claim 1, wherein said forum facilities provide an online or virtual community for said users.

36. The method as claimed in claim 12, wherein after sending said request to said search engine, said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

37. The method as claimed in claim 13, wherein after sending said request to said search engine, said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

38. The method as claimed in claim 15, wherein after sending said request to said dedicated network content evaluation server, said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

39. The method as claimed in claim 1, wherein each of said forum facilities includes at least one advertising space which can be used to display advertisements and/or sponsored links to said users.

40. The method as claimed in claim 4, wherein said rating system is at least one selected from the group consisting of a star rating system, a points rating system within a predetermined range, and a like/dislike rating system.

41. The system as claimed in claim 18, wherein said forum facilities provide an online or virtual community for said users.

42. The system as claimed in claim 28, wherein said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

43. The system as claimed in claim 29, wherein said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

44. The system as claimed in claim 31, wherein said web-browser GUI simultaneously displays said WWW content and its forum facility paired therewith: utilizing a single screen of said web-browser GUI; or, utilizing multiple screens, pop-up windows or tabs of said web-browser GUI, and wherein the display of said forum facilities within said web-browser GUI may be selectively collapsed, moved, resized and/or removed depending on a user's preference.

45. The system as claimed in claim 18, wherein each of said forum facilities includes at least one advertising space which can be used to display advertisements and/or sponsored links to said users.

46. The system as claimed in claim 20, wherein said rating system is at least one selected from the group consisting of a star rating system, a points rating system within a predetermined range, and a like/dislike rating system.

47. A method for evaluating WWW content over the Internet, said method including the steps of: providing a central repository for storing and/or sharing hyper-links, each of said hyper-links being related to a network location that contains WWW content that is independent of said central repository; providing at least one user operable terminal with controlled access to said central repository and said hyper-links stored therein; receiving and processing a request sent from said at least one user operable terminal, via said Internet, to view and/or acquire WWW content from a selected network location; and, displaying and/or providing said WWW content on and/or to said at least one user operable terminal whilst simultaneously displaying said hyper-links related to said selected network location.
